(19) United States
(12) Patent Application Publication
(10) Pub. No.: US 2005/0144453 A1
(43) Pub. Date: Jun. 30, 2005

(54) Method and system for obtaining a signing agent

(76) Inventors: Mark Berger, Kingman, AZ (US); Julie Berger, Kingman, AZ (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/984,141

(22) Filed: Nov. 9, 2004

Related U.S. Application Data
(60) Provisional application No. 60/519,039, filed on Nov. 10, 2003.

(51) Int. Cl. H04L 9/00

(52) U.S. Cl. 713/170

(57) ABSTRACT

A system for, and method of, permitting a client to locate a signing agent located within a desired area of a region is disclosed. A database is provided containing a listing of a plurality of signing agents dispersed over the region. The client is permitted to access the database to identify a signing agent located within the desired area of the region. The client is permitted to contact the identified signing agent to determine availability of the identified signing agent. The client is permitted to directly hire the identified signing agent if the identified signing agent is determined to be available. An additional signing agent is actively located if an available signing agent is not listed on the database.

### CROSS-REFERENCE TO RELATED APPLICATIONS

This application claims benefit of U.S. provisional patent application, Ser. No. 60/519,039, filed Nov. 10, 2003.

### FEDERALLY SPONSORED RESEARCH OR DEVELOPMENT

Not Applicable.

### TECHNICAL FIELD

The present invention relates to a method of, and system for, locating and obtaining a signing agent.

### BACKGROUND OF THE INVENTION

A nationwide signing company is a company that locates signing agents, such as notaries and attorneys, for a fee to witness the signing of mortgage documents, such as refinances, lines of credit and seconds, at a location of the client's choice. Signing companies typically currently hire signing agents as subcontractors.

The signing companies clients are mortgage and title companies who hire the signing company to locate the signing agent for a specific signing. Signing agents are located, for a specific order, through various methods, and then are added to a signing company's internal database for future hire. An average internal database throughout the industry includes approximately 10,000 to 15,000 signing agents.

To locate a signing agent outside the signing company's internal database, a signing company typically will go to various online databases. These online databases have been built throughout the industry via word of mouth and various notary boards within the industry. A signing agent will sign up onto the online database, usually for a fee. These databases usually become quickly outdated, as there typically is no means of follow up. Signing companies will also recruit via yellow pages under real estate, insurance companies, funeral homes, mailbox etc., courthouses, etc., anywhere they may find a notary willing to learn, for a specific location.

While these prior art systems and methods functioned effectively in certain situations, they were not effective in situations where there were no listed signing agents available at the necessary time and/or location.

### BRIEF DESCRIPTION OF THE DRAWINGS

FIG. 1a block diagram of a system according to the present invention.

### DETAILED DESCRIPTION OF A PREFERRED EMBODIMENT

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated.

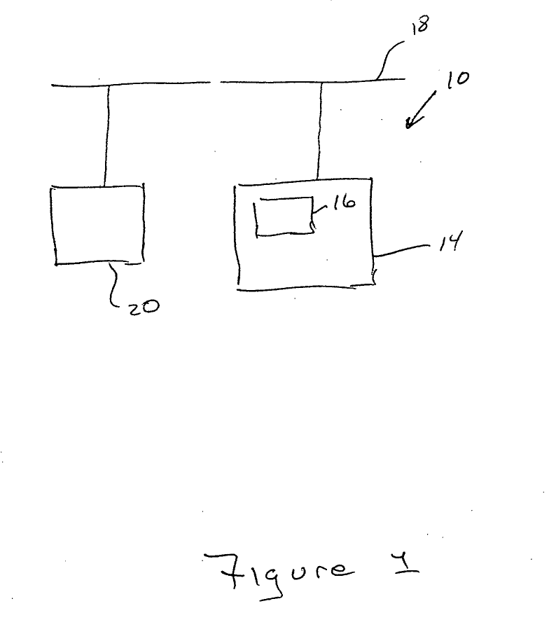

A system 10 for permitting a client 12 to locate a signing agent located in a desired area, such as a town, of a region, such as the United States, is illustrated in FIG. 1. The system 10 is likely operated by a signing company.

The system 10 comprises a computer 14 including memory 16 onto which a database is stored. The database contains a listing of many signing agents dispersed over the region. There is no charge to the signing agent to be listed on the database.

The system 10 is conventionally connected to the internet 18, and clients can access the database from a conventional computer terminal 20 via the internet 18 in a conventional manner. Access to the database can be limited, such as by a requirement for a pre-established user name and password. Clients would pay a periodic fee, such as annually, for access to the database. Clients access the database to identify a signing agent located within the desired area of the region.

Once a client has logged on to the database, the client searches for, and, if available, obtains, contact information regarding the identified signing agent. With the contact information, the client contacts the identified signing agent to determine the availability of the signing agent at the desired location and time. If available, the client independently contracts with the signing agent for the necessary services.

The system 10 receives input from the client, advising the system 10 whether the client was successful in locating, and contracting with, an available signing agent. If no such signing agent is available, the client advises the system 10 that the client was unable to locate, and contract with, an available signing agent, and the system 10 generates a message, indicating the time when, and place where, the client needs the signing agent. If such a message is generated, an operator of the system 12 responds using conventional means to independently locate a signing agent not already listed on the database. Once located, this additional signing agent is tested to ensure qualifications. If qualified, the system 10 informs the client, and the new signing agent is added to the database. If not qualified, the system operator will locate another, yet unlisted, signing agent, until a qualified, available signing agent is located. Thus the client is effectively assured of obtaining a signing agent, without any additional effort on the part of the client.

Prior to being listed on the database, each of the signing agents is pre-qualified, using an on-line prequalification examination.

To keep the database current, the database is actively updated, adding new signing agents, and removing others.

The system 10 further includes a link to a web-site to provide directions to the client. The system 10 also includes a link to a website providing tracking assistance for documents sent to the client.

The system 10 further permits the client to rate the signing agent and to post the rating information on the database.

The database also includes information regarding availability of the signing agents, so that the client does not contact the signing agent to perform signing services during a time of known unavailability.

The signing company no longer pays the signing agent as a subcontractor. Rather, the client will directly hire the signing agent. While this aspect is generally available with current online systems discussed above, according to the present invention, the signing company actively obtains a signing agent for the client if an available signing agent is not listed on the database. Additionally, the signing company operating the system 10 will be consistently, actively recruiting and training; via the internet, signing agents in all areas, not just for specific locations for specific signings.

The system 10 allows for automatic generated confirmations of date, location, and fee for the signing agent to the signing agent, direct from the client. The system 10 will provide separate reports to the client regarding past, current and future signing appointments. The system 10 also provides client administrative rights to manage its own users.

The signing company will not charge the signing agent any fees to be listed on the database, which will encourage signing agents to be listed, thereby making the database more complete. The information will be constantly updated, constantly recruiting for all areas.

While a specific embodiment has been illustrated and described, numerous modifications may come to mind without significantly departing from the spirit of the invention, and the scope of protection is only limited by the scope of the accompanying Claims.

1. A method of permitting a client to locate a signing agent located within a desired area of a region, the method comprising:
providing a database containing a listing of a plurality of signing agents dispersed over the region;
permitting the client to access the database to identify a signing agent located within the desired area of the region;
permitting the client to contact the identified signing agent to determine availability of the identified signing agent;
permitting the client to directly hire the identified signing agent if the identified signing agent is determined to be available; and
actively locating an additional signing agent not listed on the database if the identified signing agent is determined not to be available.

2. The method of claim 1, wherein the database is accessed via the internet.

3. The method of claim 1, including pre-qualifying each of the signing agents before adding each of the signing agents to the database.

4. The method of claim 1, wherein the client subscribes to access the database.

5. The method of claim 1, wherein the database is actively updated with additional signing agents.

6. The method of claim 1 including pre-qualifying the additional signing agent.

7. The method of claim 6 including adding the additional signing agent to the database.

8. The method of claim 1 including providing web-accessed directions to the selected signing agent.

9. The method of claim 1 including providing web-accessed tracking assistance for documents sent the selected signing agent.

10. The method of claim 1 including permitting the client to add rating information about the signing agent to the database.

11. The method of claim 1, wherein the database includes information regarding availability of the signing agents.

12. A system for permitting a client to locate a signing agent located in a desired area of a region, the system comprising:
a database containing a listing of a plurality of signing agents dispersed over the region;
means for permitting the client to access the database to identify a signing agent located within the desired area of the region;
means for providing to the client contact information regarding the identified signing agent to permit the client to contact the identified signing agent to determine the availability of the signing agent;
means responsive to input from the client for determining whether the client located an available signing agent; and
means for generating a message if it is determined the client was unable to locate an available signing agent.

13. The system of claim 12, including means for accessing the database via the internet.

14. The system of claim 12, including means for pre-qualifying each of the signing agents on-line before adding each of the signing agents to the database.

15. The system of claim 12, including means for determining whether the client has subscribed to access the database.

16. The system of claim 12, wherein the database is actively updated with additional signing agents.

17. The system of claim 12 including a link to a web-site to provide directions to the client.

18. The system of claim 12 including a link to a web-site providing tracking assistance for documents sent to the client.

19. The system of claim 12 including means for permitting the client to add signing agent rating information to the database.

20. The system of claim 12, wherein the database includes information regarding availability of the signing agents.
